(19) United States
(12) Patent Application Publication
(10) Pub. No.: US 2016/0193727 A1
(43) Pub. Date: Jul. 7, 2016

(54) ELECTRIC POWER TOOL

(71) Applicant: HITACHI KOKI CO., LTD., Tokyo (JP)

(72) Inventor: Yuuki TAKEDA, Hitachinaka-shi (JP)

(21) Appl. No.: 14/911,440

(22) PCT Filed: Aug. 13, 2014
(86) PCT No.: PCT/JP2014/004186

§ 371 Date: Feb. 10, 2016

(30) Foreign Application Priority Data
Sep. 2, 2013 (JP) 2013-181646

(51) Int. Cl. B25F 5/00; B24B 23/02

(52) U.S. Cl. CPC B25F 5/008; B24B 23/028

(57) ABSTRACT

A disc grinder comprises: a motor serving as a driving source; a housing in which the motor is housed; a centrifugal fan mounted on an output shaft of the motor, and configured to provide cooling air for cooling the motor; and a first flow-regulating member for guiding cooling air in a radially-outward direction of the output shaft, and a second flow-regulating member for guiding cooling air guided by the first flow-regulating member toward the front end of the housing.

### TECHNICAL FIELD

The present invention relates to an electric power tool provided with a fan for cooling a motor.

### BACKGROUND ART

In order to reduce the size of an electric power tool, to reduce noises from the electric power tool, and to increase power output from the electric power tool, it is necessary to improve a fan for cooling a motor and a structure surrounding the fan. Patent Literature 1 discloses an electric power tool provided with a fan having a shape improved so as to increase a flow rate of air, and to reduce noises.

The electric power tool disclosed in Patent Literature 1 has a motor and a centrifugal fan housed in an outer frame (gear cover). The centrifugal fan has a fan body and a plurality of vanes formed on the fan body at a given pitch. An air discharge opening is provided to the gear cover so as to face the outer periphery of the fan body, and a fan guide is provided in the gear cover and radially disposed on the outside of the centrifugal fan. The fan guide is formed so as to encircle the centrifugal fan, and to communicate with the air discharge opening.

### CITATION LIST

### Patent Literature

[PTL 1]

Japanese Patent Application Laid-Open Publication No. 2004-249386

### SUMMARY OF INVENTION

### Technical Problem

Incidentally, in the conventional electric power tool, airflow from the motor toward the centrifugal fan tends to be disturbed in some cases, and the disturbed airflow prevents the increase in flow rate and cooling efficiency.

An object of the present invention is to provide an electric power tool improved in flow rate and cooling efficiency of a fan for cooling a motor.

In accordance with one aspect of the present invention, there is provided an electric power tool comprising: a motor serving as a driving source; a tool body in which the motor is housed, and which has an air intake port and an exhaust port; a centrifugal fan mounted on an output shaft of the motor, and configured to provide cooling air for cooling the motor; and a fan guide formed so as to encircle the centrifugal fan, and configured to guide the cooling air, characterized in that: an extended portion extending in a radial direction of the centrifugal fan is formed in the fan guide; and the extended portion is gradually sloped along a rotation direction of the centrifugal fan toward the exhaust port.

In accordance with another aspect of the present invention, there is provided an electric power tool comprising: a motor serving as a driving source; a tool body housing the motor therein and having an air intake port and an exhaust port; a centrifugal fan fitted on an output shaft of the motor, the centrifugal fan generating cooling air that cools the motor; a first flow-regulating member that guides the cooling air to outside of the output shaft in its radial direction; and a second flow-regulating member that guides the cooling air guided by the first flow-regulating member, toward a front end of the tool body, characterized in that the second flow-regulating member includes: a base portion; an outer wall extending from the base portion in an axial direction of the output shaft and located outside in a radial direction of the centrifugal fan; and a first extended portion extending from the outer wall toward radial interior of the centrifugal fan, wherein an axial distance between the first extended portion and the base portion is gradually reduced along a rotation direction of the centrifugal fan.

### ADVANTAGEOUS EFFECTS OF INVENTION

According to the present invention, improvement in flow rate and cooling efficiency of a fan for cooling a motor provided to the electric power tool can be achieved.

### BRIEF DESCRIPTION OF DRAWINGS

[FIG. 1]

FIG. 1 is a side view showing one example of an electric power tool according to the present invention;

[FIG. 2]

FIG. 2 is a longitudinal sectional view of the electric power tool shown in FIG. 1;

[FIG. 3]

FIG. 3 is an enlarged sectional view of the main part of the electric power tool shown in FIG. 1;

[FIG. 4]

FIG. 4 is an exploded perspective view of a fan guide;

[FIG. 5]

FIG. 5 is a side view showing a fan guide and a fan housed in the fan guide;

[FIG. 6]

FIG. 6 is a side view showing another example of the fan guide and the fan housed in the fan guide; and

[FIG. 7]

FIG. 7 is a sectional view of the fan guide and the fan housed in the fan guide.

### DESCRIPTION OF EMBODIMENTS

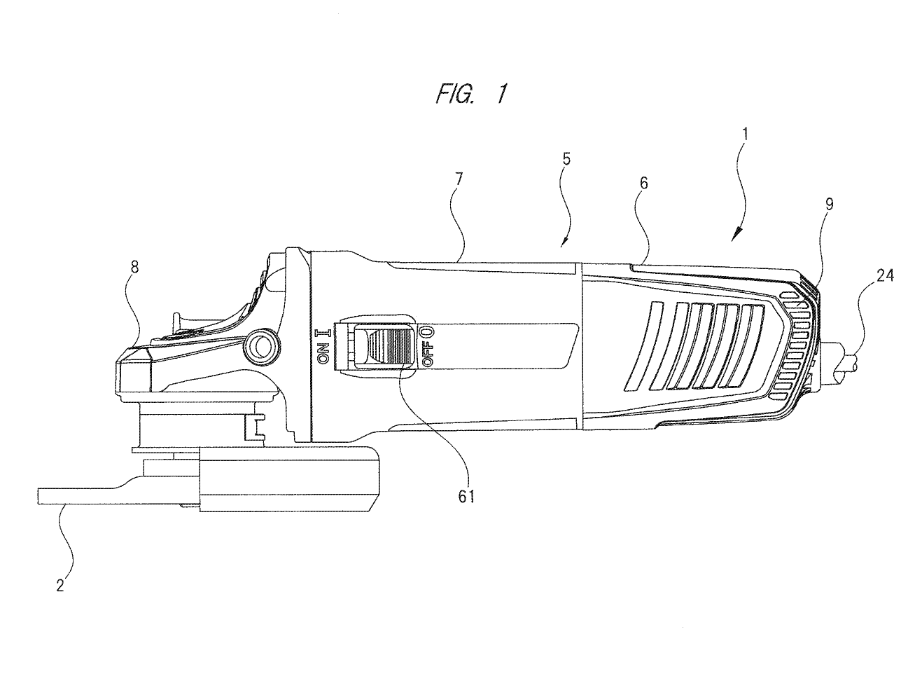

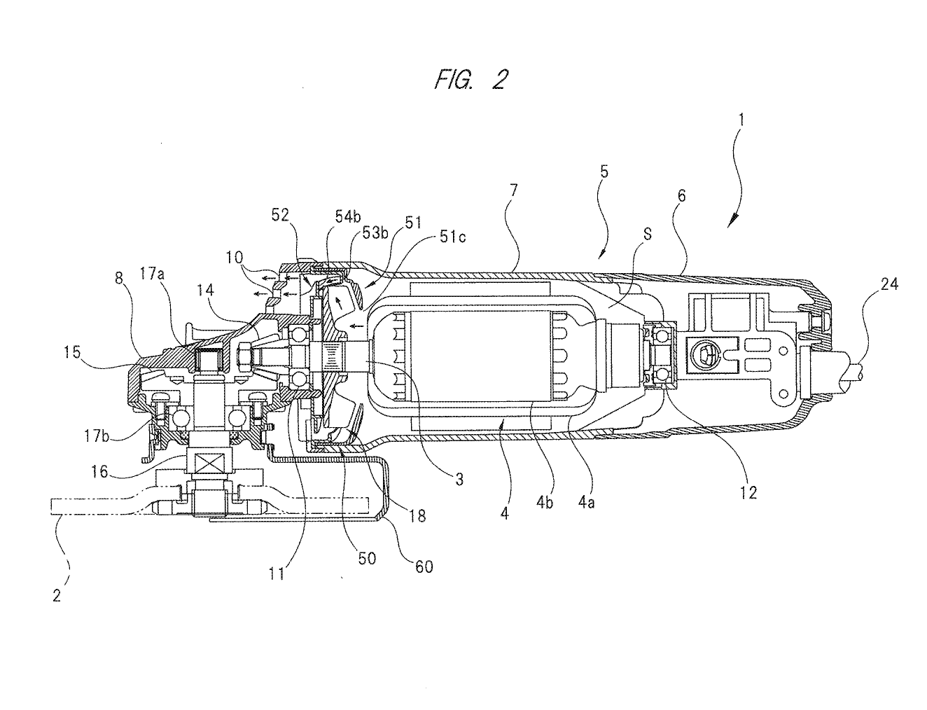

Hereinafter, one example of an embodiment of the present invention will be described with reference to the drawings. A grinding tool (disc grinder) is explained as an electric power tool according to this embodiment. FIGS. 1 and 2 show an overall configuration of a disc grinder 1 of this embodiment. As shown in FIGS. 1 and 2, the disc grinder 1 includes a grinding member 2 serving as a head tool, a motor 4 serving as a driving source for the grinding member 2, and a tool body 5 in which the motor 4 is housed. In the following description, the tool body 5 is simply referred to as “housing 5”. The left end part of the housing 5 shown in FIGS. 1 and 2 is simply referred to as “front end part”, and the right end part of the same is simply referred to as “rear end part”.

As shown in FIG. 2, the housing 5 has a tail cover 6, a motor housing 7, and a gear cover 8. The tail cover 6, the motor housing 7, and the gear cover 8 are arranged in this order in a direction toward the front end part from the rear end part of the housing 5, and they are connected to each other. As shown in FIG. 1, the rear part of the tail cover 6 is formed with air intake ports 9 for taking in air. On the other hand, as shown in FIG. 2, the front part of the gear cover 8 is formed with exhaust ports 10. An electric cord 24 for supplying electric power to the motor 4 extends from the rear end face of the tail cover 6.

The motor 4 has a stator 4a, a rotor 4b, and a rotating shaft (output shaft) 3 fixed to the rotor 4b. The output shaft 3 extends through the rotor 4b. One end of the output shaft 3 is protruding from the rotor 4b and rotatably supported by a bearing 11, and the other end of the output shaft 3 is protruding from the rotor 4b and rotatably supported by a bearing 12.

The bearing 11 provided on the front side is in the gear cover 8, and the bearing 12 provided on the rear side is in the motor housing 7. An annular channel “S” is formed between the motor housing 7 and the motor 4, air (as cooling air) taken from the air intake ports 9 (FIG. 1) can flow through the annular channel “S” toward the front from the rear.

A driven shaft 16 crossing the output shaft 3 at right angles is disposed in the gear cover 8. The driven shaft 16 is rotatably supported by bearings 17a and 17b. The driven shaft 16 is provided with a driven gear 15 engaging with a driving gear 14 provided to the output shaft 3, and the grinding member 2 is attached to the tip (lower end part) of the driven gear 16.

A centrifugal fan 18 for providing cooling air for cooling the motor 4 is fixed to the output shaft 3 by, for example, press-fitting. Furthermore, in order to efficiently provide cooling air, to increase flow rate, and to improve cooling efficiency, a fan guide 50 is disposed so as to encircle the centrifugal fan 18.

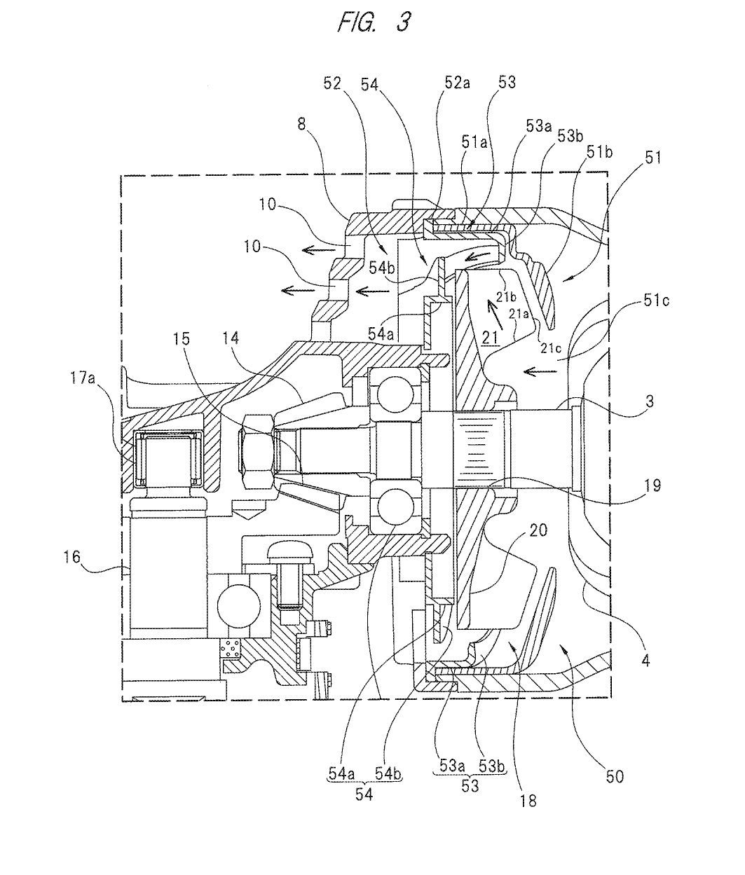

As shown in FIG. 3, the centrifugal fan 18 has a circular base 20 formed with a shaft hole 19 axially aligned with its center axis, and a plurality of vanes 21 formed on the surface of the base 20. The output shaft 3 of the motor 4 is inserted in the shaft hole 19 by press-fitting. Each of the vanes 21 has an inner edge 21a and an outer edge 21b, which rise from the base 20, and has a front edge 21c continuous from the inner edge 21a to the outer edge 21b.

The fan guide 50 has a first flow-regulating member 51 for guiding cooling air in a radially-outward direction of the output shaft 3, a second flow-regulating member 52 for guiding cooling air guided by the first flow-regulating member 51 toward the front end side of the housing 5.

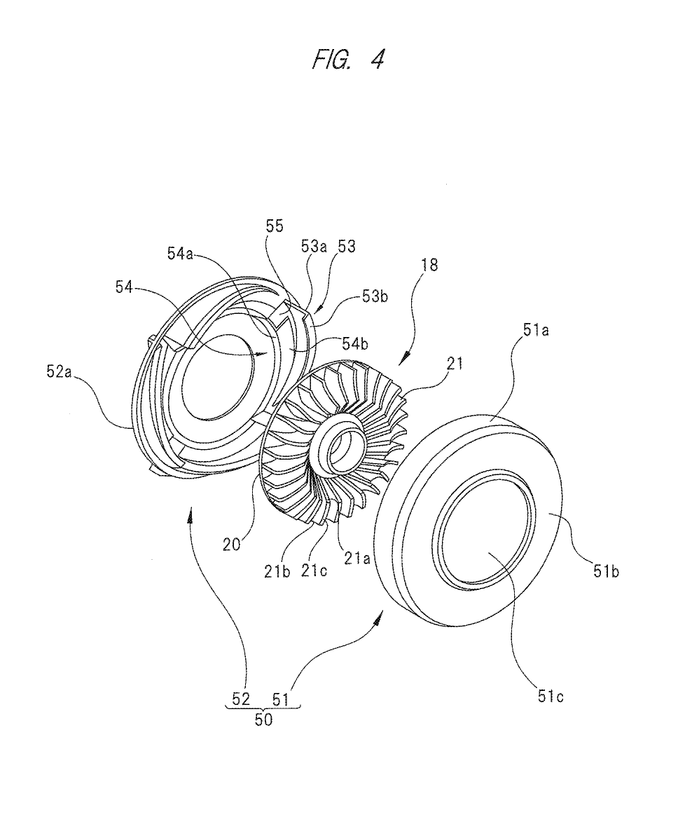

As shown in FIG. 4, the first flow-regulating member 51 forming part of the fan guide 50 has a cylindrical portion 51a, a cup portion 51b partially covering one opening of the cylindrical portion 51a, and a through-hole 51c formed at the center of the cup portion 51b. The second flow-regulating member 52 forming part of the fan guide 50 has a disc-shaped base portion 52a, and outer flow-regulating portions 53 and inner flow-regulating portions 54, which are formed on the base portion 52a.

As shown in FIG. 3, the centrifugal fan 18 is disposed between the first flow-regulating member 51 and the second flow-regulating member 52, which are assembled together. In other words, the centrifugal fan 18 is substantially covered with the fan guide 50 composed of the first flow-regulating member 51 and the second flow-regulating member 52.

The cylindrical portion 51a of the first flow-regulating member 51 is fitted into the front end part of the motor housing 7, while the cup portion 51b of the first flow-regulating member 51 extends between the motor 4 and the centrifugal fan 18.

Specifically, the cup portion 51b extends inwardly in the radial direction so as to cover the vanes 21 along their front edges 21c.

It is preferable that the cup portion 51b be sloped along the front edges 21c of the vanes 21. The cup portion 51b suppresses the disturbance of an airflow traveling through the channel “S” (FIG. 2) toward the centrifugal fan 18. As a result, the airflow is guided smoothly through the through-hole 51c to the front face of the centrifugal fan 18.

As shown in FIG. 4, each of the outer flow-regulating portions 53 of the second flow-regulating member 52 has an arcuate outer wall 53a located outside in the radial direction of the centrifugal fan 18, and a first extended portion 53b extending radially inward from the upper end of the outer wall 53a. Additionally, the edge of the base portion 52a of the second flow-regulating member 52 has a flange shape and further protrudes outwardly in comparison with the outer wall 53a.

In this embodiment, along the rotation direction of the centrifugal fan 18, four outer flow-regulating portions 53 are provided on the base portion 52a, and inner flow-regulating portions 54 are respectively provided on the inner side of the outer flow-regulating portions 53.

Each of the inner flow-regulating portions 54 has an inner wall 54a located on the inside in a radial direction of the centrifugal fan 18, and a second extended portion 54b extending radially outward from the upper end of the inner wall 54a. The outer walls 53a of the outer flow-regulating portions 53 face the respective inner walls 54a of the inner flow-regulating portions 54 in the radial direction. Furthermore, the first extended portions 53b of the outer flow-regulating portions 53 and the second extended portions 54b of the inner flow-regulating portions 54 radially extend in respective directions opposite to each other, and they are lined up along the axial direction. The second extended portions 54b are opposite to the base 20 of the centrifugal fan 18 in the axial direction (see FIG. 3). In other words, each of the second extended portions 54b serves as a portion opposite to the centrifugal fan 18.

As shown in FIG. 4, on the base portion 52a of the second flow-regulating member 52, openings 55 through which cooling air can flow are formed between the outer flow-regulating portions 53 and the inner flow-regulating portions 54, which face each other. Specifically, the openings 55 are formed between the outer walls 53a and the inner walls 54a opposite to each other, respectively. The openings 55 are on the same plane as that of the base portion 52a. In other words, the opening faces of the openings 55 are respectively parallel to the surfaces of the base portion 52a.

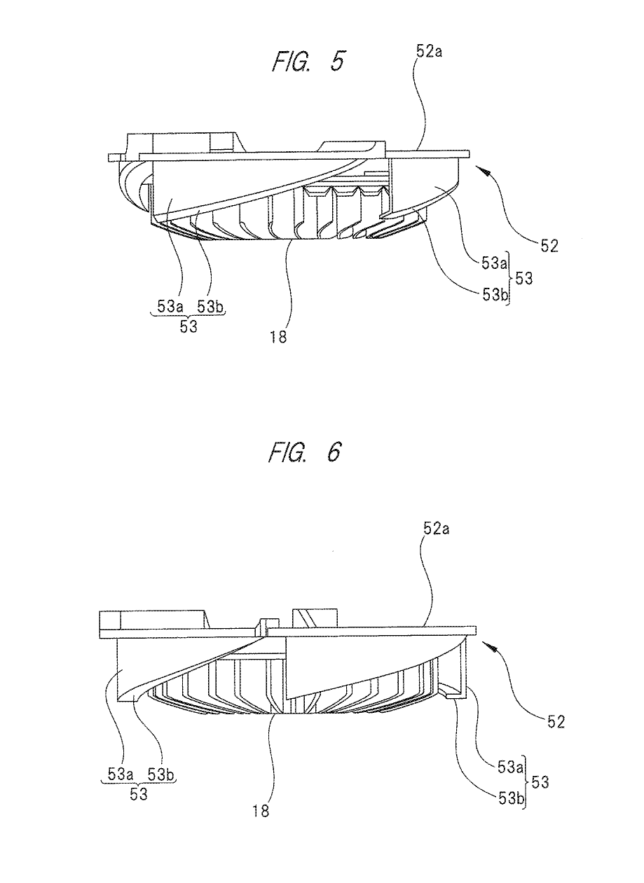

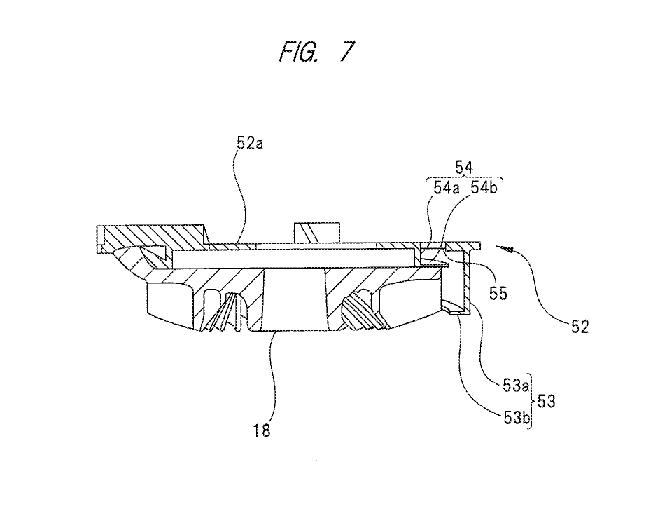

As shown in FIGS. 4 to 7, the first extended portions 53b of the outer flow-regulating portions 53 and the second extended portions 54b of the inner flow-regulating portions 54 is sloped so as to gradually approach the opening faces of the openings 55 along the rotation direction of the centrifugal fan 18. In other words, each of the first and second extended portions 53b and 54b is formed into a sloped shape and sloped toward the front side of the housing 5 (FIG. 2).

The first extended portion 53b and the second extended portion 54b are sloped toward the front side of the housing 5 as shown in FIG. 3, since the front part of the housing 5 is provided with the exhaust ports 10. That is, by sloping the extended portions (the first extended portions 53b and the second extended portions 54b in this embodiment) toward the exhaust ports 10, cooling air can be surely guided to the exhaust ports 10. In this embodiment, the base portion 52a is provided with four openings 55. Each of the openings 55 is provided in front of the slope of the extended portions 53b and 54b along the rotation direction of the centrifugal fan 18. In other words, each of the openings 55 is formed in front of the end of the slope closest to the front side of the housing 5. More specifically, each of the openings 55 is formed at a position at which the axial distance between the end of the extended portions 53b and 54b and the base portion 52a becomes minimum, or in the vicinity of that position.

Cooling air is guided along the first extended portion 53b (slope) so as to flow through the openings 55 to reach the exhaust ports 10. Therefore, disturbed flow is hardly created in the channel leading to the exhaust ports 10, and flow rate can be increased. Additionally, each shape of the first extended portion 53b and the second extended portion 54b may be given under the condition that the given shape gradually extends forward (toward the exhaust ports) along the rotation direction of the centrifugal fan 18. That is, if the extended portions 53b and 54b are formed so that the axial distance between the extended portions 53b and 54b and the base portion 52a is gradually reduced along the rotation direction of the centrifugal fan 18, the shape and slope of the extended portions 53b and 54b are not limited to a specific shape and slope.

As shown in FIG. 3, the opening end of the cylindrical portion 51a of the first flow-regulating member 51 is in contact with the edge of the base portion 52a which is protruding so as to form a flange on the outside of the outer flow-regulating portions 53. And, the edge of the base portion 52a is protruding radially-outwardly in comparison with the cylindrical portion 51a, and this protruding portion is held between the motor housing 7 and the gear cover 8. As shown in FIG. 2, the gear cover 8 is provided with a cover 60 covering the rear half of the grinding member 2. As shown in FIG. 1, a switch 61 for switching on and off the motor 4 (FIG. 2) is disposed on a side face of the motor housing 7.

Then, the operation of the disc grinder 1 will be described with reference to, mainly, FIG. 2. By turning on the switch 61 (see FIG. 1) of the motor 4 to rotate the output shaft 3 of the motor 4, the centrifugal fan 18 is rotated. At the same time, a rotation driving force is transmitted to the driven shaft 16 via the driving gear 14 and the driven gear 15, and the grinding member 2 attached to the driven shaft 16 is rotated. At this time, the rotating centrifugal fan 18 creates airflow from the radial interior of the centrifugal fan 18 toward the radial exterior of the same. As a result, cooling air is sucked into the air intake ports 9 (FIG. 1) provided on the tail cover 6. After being sucked into the air intake ports 9, the cooling air flows through the channel “S” formed between the motor housing 7 and the motor 4 and reaches the centrifugal fan 18. Since the fan guide 50 (first flow-regulating member 51) is disposed between the centrifugal fan 18 and the motor 4, the cooling air is then guided along the first flow-regulating member 51 to the through-hole 51c of the first flow-regulating member 51 (i.e., suction port of the centrifugal fan 18), and consequently flows into the fan guide 50. After flowing into the fan guide 50, the cooling air is caught in the rotation of the centrifugal fan 18, and flows radially outward along the first flow-regulating member 51.

After flowing radially outward along the first flow-regulating member 51, the cooling air is guided to the openings 55 (FIG. 4) while swirling spirally along the sloped extended portions 53b and 54b of the second flow-regulating member 52, and enters the inner space of the gear cover 8 via the openings 55. After entering the inner space of the gear cover 8, the cooling air is discharged to the outside of the disc grinder 1 via the exhaust ports 10. In this manner, the motor 4 is cooled effectively as cooling air sucked in through the air intake ports 9 formed on the rear part of the tail cover 6 flows through the motor housing 7 toward the front part of the disc grinder 1.

Furthermore, cooling air introduced into the fan guide 50 (the first flow-regulating member 51 and the second flow-regulating member 52) is guided certainly to the openings 55 along the sloped extended portions 53b and 54b (i.e., the slope) of the second flow-regulating member 52. As a result, this process suppresses convection flow of the cooling air in the fan guide 50, the flow rate of the cooling air is increased, and the cooling effect of the motor 4 is enhanced.

Furthermore, if a control circuit for controlling the motor 4 is disposed in a space between the air intake ports 9 and the motor 4 in the motor housing 7, the control circuit can also be cooled. For example, if the control circuit is disposed in the channel “S”, the control circuit can also be cooled. Specifically, in the case where a brushless motor is used as the motor 4, since a switching element for controlling the brushless motor generates heat, it is preferable that the switching element be disposed in the channel “S”.

Furthermore, since the second extended portions 54b opposite to the centrifugal fan 18 are sloped along the rotation direction of the centrifugal fan 18, it is possible to suppress the generation of eddying flow in a gap between the centrifugal fan 18 and the second extended portions 54b, thereby increasing the flow rate of cooling air.

As described above, the disc grinder 1 according to this embodiment is improved so as to increase the flow rate of cooling air for cooling the motor 4, and so as to enhance its cooling efficiency. Additionally, after cooling the motor 4, the cooling air is discharged from the exhaust ports 10 provided on the front part of the motor housing 7. It is, therefore, possible to prevent an operator from being exposed to this cooling air.

The electric power tool according to the present invention is not limited by the above embodiment, and it will be obvious to those skilled in the art that various modifications may be made without departing from the scope of the invention. The present invention may be also applied to electric power tools other than the disc grinder (such as for example, cutting tools, power-actuated drills, screw-fastening machines). In other words, the present invention can be applied to every type of electric power tool having a fan and a fan guide.

1. An electric power tool comprising:
a motor serving as a driving source;
a tool body in which the motor is housed, and which has an air intake port and an exhaust port;
a centrifugal fan mounted on an output shaft of the motor, and configured to provide cooling air for cooling the motor; and
a fan guide formed so as to encircle the centrifugal fan, and configured to guide the cooling air,
wherein an extended portion extending in a radial direction of the centrifugal fan is formed in the fan guide; and
wherein the extended portion is gradually sloped along a rotation direction of the centrifugal fan toward the exhaust port.

2. The electric power tool according to claim 1, wherein the extended portion is formed into a sloped shape, and sloped along the rotation direction of the centrifugal fan toward the exhaust port.

3. The electric power tool according to claim 2, wherein an opening allowing the cooling air to flow therethrough is formed in front of a slope of the extended portion in the rotation direction of the centrifugal fan.

4. The electric power tool according to claim 1, comprising a portion opposite to the centrifugal fan in an axial direction of the centrifugal fan, the portion being sloped along the rotation direction of the centrifugal fan toward the exhaust port.

5. An electric power tool comprising:
a motor serving as a driving source;
a tool body housing the motor therein and having an air intake port and an exhaust port;
a centrifugal fan fitted on an output shaft of the motor, the centrifugal fan generating cooling air that cools the motor;
a first flow-regulating member that guides the cooling air to outside of the output shaft in its radial direction; and a second flow-regulating member that guides the cooling air guided by the first flow-regulating member, toward a front end of the tool body,
wherein the second flow-regulating member includes: a base portion; an outer wall extending from the base portion in an axial direction of the output shaft and located outside in a radial direction of the centrifugal fan; and a first extended portion extending from the outer wall toward radial interior of the centrifugal fan,
wherein an axial distance between the first extended portion and the base portion is gradually reduced along a rotation direction of the centrifugal fan.

6. The electric power tool according to claim 5, wherein the first extended portion is gradually sloped along the rotation direction of the centrifugal fan toward the exhaust port.

7. The electric power tool according to claim 6, wherein an opening allowing the cooling air to flow therethrough is provided in front of a slope of the first extended portion in the rotation direction of the centrifugal fan.

8. The electric power tool according to claim 7, wherein
the second flow-regulating member includes: a second extended portion facing the centrifugal fan in the axial direction,
the first extended portion is gradually sloped along the rotation direction of the centrifugal fan toward the exhaust port.

9. The electric power tool according to claim 8, wherein
the second flow-regulating member includes an outer flow-regulating portion having the first extended portion, and an inner flow-regulating portion having the second extended portion,
the opening is formed between the outer flow-regulating portion and the inner flow-regulating portion, and
the first extended portion and the second extended portion are each formed into a sloped shape, and sloped along the rotation direction of the centrifugal fan toward a front side of the tool body.
